(19) United States
(12) Patent Application Publication
(10) Pub. No.: US 2006/0072493 A1
(43) Pub. Date: Apr. 6, 2006

(54) Roaming techniques for a communications network

(76) Inventors: Boris E. Ginzburg, Haifa (IL); Max V. Fudim, Kiriat Byalik (IL); Ilan Bressler, Rishon Le-Zion (IL)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/952,897

(22) Filed: Sep. 28, 2004

(51) Int. Cl. H04Q 7/00

(52) U.S. Cl. 370/328

(57) ABSTRACT

Method and apparatus to manage roaming for a wireless network are described.

### BACKGROUND

A wireless communication system typically includes a wireless access point and a mobile device. The mobile device may comprise a laptop or handheld computer equipped with a wireless transceiver. One characteristic of a mobile device is that it may be conveniently moved from one location to another location. Movement of the mobile device, however, may affect communications between the wireless access point and mobile device. Consequently, there may be a need for improvements in a wireless communication system to compensate for movement of the mobile device.

### BRIEF DESCRIPTION OF THE DRAWINGS

FIG. 1 illustrates a block diagram of a system 100.

FIG. 2 illustrates a block diagram of a roam management module (RMM) 112.

FIG. 3 illustrates a block diagram of a programming logic 300.

### DETAILED DESCRIPTION

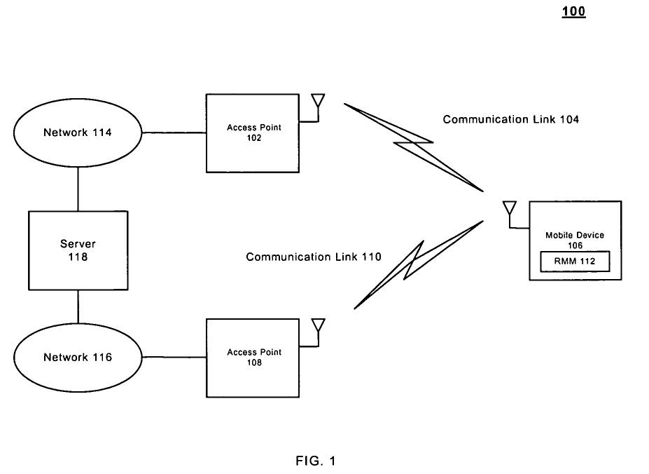

FIG. 1 illustrates a block diagram of a system 100. System 100 may comprise, for example, a communication system having multiple nodes. A node may comprise any physical or logical entity having a unique address in system 100. Examples of a node may include, but are not necessarily limited to, a computer, server, workstation, laptop, ultra-laptop, handheld computer, cellular telephone, personal digital assistant (PDA), router, switch, bridge, hub, gateway, wireless access point (WAP), and so forth. The unique address may comprise, for example, a network address such as an Internet Protocol (IP) address, a device address such as a Media Access Control (MAC) address, and so forth. The embodiments are not limited in this context.

The nodes of system 100 may be connected by one or more types of communications media and input/output (I/O) adapters. The communications media may comprise any media capable of carrying information signals. Examples of communications media may include metal leads, printed circuit boards (PCB), backplanes, switch fabric, semiconductor material, twisted-pair wire, co-axial cable, fiber optics, radio frequency (RF) spectrum, and so forth. An information signal may refer to a signal which has been coded with information. The I/O adapters may be arranged to operate with any suitable technique for controlling information signals between nodes using a desired set of communications protocols, services or operating procedures. The I/O adapters may also include the appropriate physical connectors to connect the I/O adapters with a corresponding communications media. Examples of an I/O adapter may include a network interface, a network interface card (NIC), radio/air interface, disc controllers, video controllers, audio controllers, and so forth. The embodiments are not limited in this context.

The nodes of system 100 may be configured to communicate different types of information, such as media information and control information. Media information may refer to any data representing content meant for a user, such as voice information, video information, audio information, text information, alphanumeric symbols, graphics, images, and so forth. Control information may refer to any data representing commands, instructions or control words meant for an automated system. For example, control information may be used to route media information through a system, or instruct a node to process the media information in a predetermined manner.

The nodes of system 100 may communicate media and control information in accordance with one or more protocols. A protocol may comprise a set of predefined rules or instructions to control how the nodes communicate information between each other. The protocol may be defined by one or more protocol standards as promulgated by a standards organization, such as the Internet Engineering Task Force (IETF), International Telecommunications Union (ITU), the Institute of Electrical and Electronics Engineers (IEEE), and so forth. For example, system 100 may operate in accordance with one or more wireless Local Area Network (LAN) protocols, such as the IEEE 802.11 or 802.16 series of wireless LAN protocols.

Referring again to FIG. 1, system 100 may comprise nodes 102, 106, 108 and 118. Although FIG. 1 is shown with a limited number of nodes in a certain topology, it may be appreciated that system 100 may include more or less nodes in any type of topology as desired for a given implementation. The embodiments are not limited in this context.

As shown in FIG. 1, system 100 may comprise nodes 102, 106, and 108. In one embodiment, for example, nodes 102, 106 and 108 may comprise wireless nodes arranged to communicate information over wireless communication media, such as RF spectrum. The wireless nodes may include components and interfaces suitable for communicating information signals over the designated RF spectrum. For example, the wireless nodes of system 100 may include omni-directional antennas, wireless RF transceivers, amplifiers, filters, control logic, and so forth. Examples of a wireless node may include a mobile or cellular telephone arranged for data communications, a computer equipped with a wireless access card or modem, a handheld client device such as a wireless PDA, a WAP, a base station, a mobile subscriber center, a radio network controller, and so forth. Although the embodiments may be illustrated in the context of a wireless communications system, it may be appreciated that the principles discussed herein may also be implemented in a wired communications system as well. The embodiments are not limited in this context.

In one embodiment, system 100 may comprise nodes 102 and 108. Nodes 102 and 108 may comprise, for example, wireless access points arranged to communicate media and control information in accordance with one or more mobile devices, such as node 106. WAP 102 and WAP 108 may communicate with the mobile devices using one or more communication protocols, such as the IEEE 802.11 or 802.16 series of wireless LAN protocols, for example. WAP 102 and WAP 108 may be connected to networks 114 and 116, respectively. The embodiments are not limited in this context.

In one embodiment, system 100 may comprise node 106. Node 106 may comprise, for example, a mobile device. Examples of a mobile device may include a mobile or cellular telephone arranged for data communications, a computer equipped with a wireless access card or modem, a handheld client device such as a wireless PDA, and so forth. In one embodiment, for example, mobile device 106 may comprise a mobile device developed in accordance with the Personal Internet Client Architecture (PCA) by Intel® Corporation. The embodiments are not limited in this context.

In one embodiment, mobile device 106 may further include a roam management module (RMM) 112. RMM 112 may control and manage roaming operations for mobile device 106. Roaming may refer to movement of mobile device 106 from one location to another location. Movement of mobile device 106 may affect communications between a WAP and mobile device 106. For example, assume mobile device 106 establishes a connection with WAP 102. WAP 102 may have a certain transmission range, such as 300 feet, for example. Whenever mobile device 106 moves away from WAP 102, the connection between WAP 102 and mobile device 106 may degrade in proportion to the increase in distance between the two devices. RMM 112 may manage communications for mobile device 106 to compensate for such movement of mobile device 106. For example, RMM 112 may manage communications for mobile device 106 as it moves away from WAP 102 and towards WAP 108.

In one embodiment, system 100 may include networks 114 and 116. Networks 114 and 116 may comprise, for example, packet networks used to communicate packets of information between various network nodes. Networks 114 and 116 may comprise data networks or voice networks suitable for data communications. When networks 114 and 116 are implemented as data networks, WAP 102 and WAP 108 may include wired or wireless network interface cards and/or the appropriate connectors to interface with networks 114 and 116, respectively. When networks 114 and 116 are implemented as voice networks, WAP 102 and WAP 108 may further include a modem to establish a data connection over the voice network. Examples of suitable modems may include a cable modem or digital subscriber loop (DSL) modem. The embodiments are not limited in this context.

In one embodiment, system 100 may include a server 118. Server 118 may comprise a server having application programs and/or data accessible by mobile device 106. Server 118 may be implemented as, for example, a web server having hypertext markup language (HTML) or extensible markup language (XML) documents. Server 118 may also include one or more server applications to communicate data to one or more client applications executed by mobile device 106. An example of a server application may include an electronic mail server, and an example of a client application may include an electronic mail program.

Server 118 and mobile device 106 may communicate information using a number of different communication paths. For example, server 118 and mobile device 106 may communicate information via network 114 and WAP 102. In another example, server 118 and mobile device 106 may communicate information via network 116 and WAP 108. The embodiments are not limited in this context.

In general operation, system 100 may operate to communicate media and control information over one or more communication channels established between the various nodes of system 100. For example, mobile device 106 may establish a first connection with a first WAP, such as WAP 102 over communication link 104. The first connection may be used to, for example, initiate a communication session between mobile device 106 and server 118. The communication session may comprise any communication session, such as browsing the Internet, client-server operations, servicing an application program, remote maintenance and upgrades, and so forth. The user of mobile device 106 may move mobile device 106 to a different location, thereby potentially degrading the quality of the first connection over communication link 104. Alternatively, varying levels of interference may also degrade the quality of the first connection even when mobile device 106 remains stationary.

RMM 112 may be arranged to manage roaming operations for mobile device 106. RMM 112 may monitor communication link 104 and determine whether the quality of the first connection goes below a certain threshold. If RMM 112 determines that the first connection has degraded below the threshold, RMM 112 may search for a second WAP, such as WAP 108. RMM 112 may terminate the first connection with WAP 102, and create a second connection with WAP 108 over communication link 110. RMM 112 may create the second connection with WAP 108 for the same or different communication session established using the first connection with WAP 102.

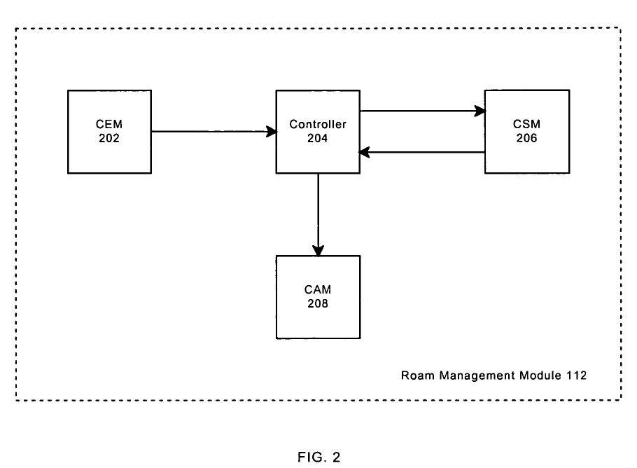

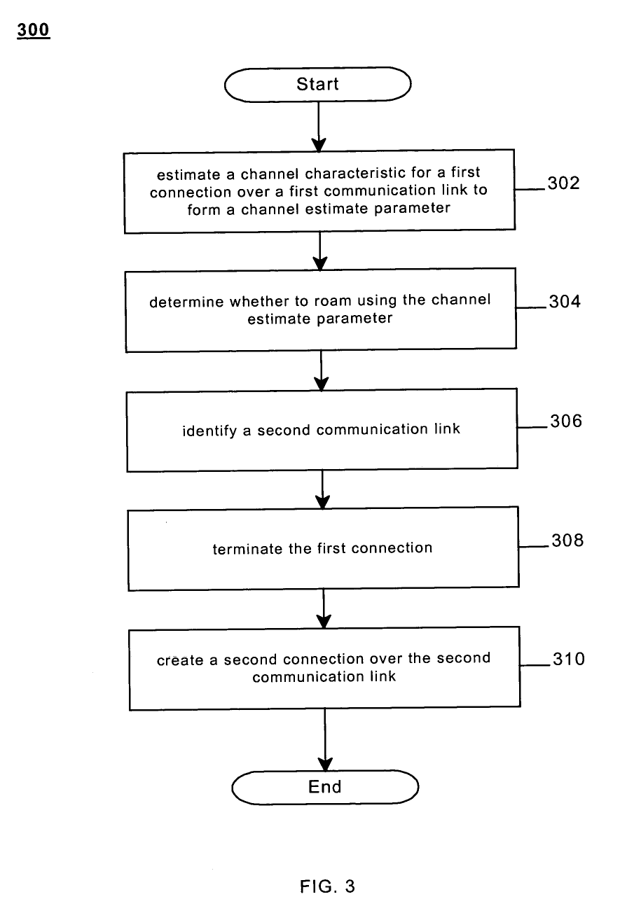

RMM 112 may provide several advantages over conventional techniques. For example, a mobile device typically attempts to re-establish a connection with a WAP only after the connection has failed. By way of contrast, RMM 112 may begin scanning for a new WAP as soon as the communication link with the current WAP begins to degrade. This may allow mobile device 106 and server 118 sufficient time to save data prior to making the switch, thereby improving data integrity. Further, RMM 112 may allow a communication session with server 118 to continue with reduced or limited interruptions caused by degradation of the communication channel and/or communication link between mobile device 106 and WAP 102. System 100 in general, and RMM 112 in particular, may be described in more detail with reference to FIGS. 2-3.

FIG. 2 illustrates a block diagram of RMM 112. As shown in FIG. 2, RMM 112 may comprise multiple elements, such as channel estimate module (CEM) 202, link controller 204, channel scan module (CSM) 206, and a channel association module (CAM) 208. Some elements may be implemented using, for example, one or more circuits, components, registers, processors, software subroutines, or any combination thereof. Although FIG. 2 shows a limited number of elements, it can be appreciated that more or less elements may be used in subsystem 200 as desired for a given implementation. The embodiments are not limited in this context.

As discussed previously, RMM 112 may manage roaming operations for a mobile device, such as mobile device 106. RMM 112 may periodically suspend an existing connection over a current communication link to a first WAP for a short period of time, and may use this time to scan for other wireless access points. If the quality of the current link goes below a predetermined threshold, RMM 112 may select a second WAP discovered during the pre-emptive scanning, establish a connection with the second WAP, and thereby move communications from the first WAP to the second WAP. This may reduce interruptions and latency between mobile device 106 and server 118, thereby increasing overall system performance and user satisfaction.

In one embodiment, RMM 112 may include CEM 202. CEM 202 may perform channel estimation for a communication link, such as communication links 104 and/or 110. CEM 202 may estimate one or more channel characteristics for a communication channel or link. Examples of channel characteristics may include channel impulse responses, amplitude levels, shapes of the signals, signal distortion, crosstalk impulse responses, temporal shifts and delays, and so forth. The channel characteristics may also include other statistics associated with the information communicated over the communication link, such as a receive signal strength indicator (RSSI), a packet error rate (PER), error detection parameters, and so forth. An example of error detection may include a number of bit errors detected for each packet using various error detection techniques, such as cyclic redundancy check (CRC). The measured channel characteristics may be used to form a channel estimate parameter. The channel estimate parameter may be used by link controller 204 to measure the quality of a communication link.

CEM 202 may perform channel estimation in a number of different ways. For example, CEM 202 may perform channel estimation in response to an external request, such as from a user of mobile device 106, a WAP, a component of RMM 112 such as link controller 204, another subsystem of mobile device 106, and so forth. CEM 202 may also perform channel estimation on a continuous basis, thereby constantly monitoring a given communication channel for reduced quality. Further, CEM 202 may also perform channel estimation on a periodic basis. For example, CEM 202 may perform channel estimation at periodic intervals, such as every 10 seconds. The time period may vary for a given implementation, and the embodiments are not limited in this context.

In one embodiment, RMM 112 may include link controller 204. Link controller 204 may manage the overall operation of RMM 112. Link controller 204 may receive the channel estimate parameter from CEM 202, and determine whether to initiate roaming operations using the channel estimate parameter. For example, link controller 204 may compare the channel estimate parameter to a predetermined value. Link controller 204 may generate a scan message in accordance with the results from the comparison. If the result indicates a degradation in the quality of the communication channel, link controller 204 may output the scan message to CSM 206 to begin searching for an alternate WAP.

The predetermined value may be set for a desired level of quality associated with the channel estimate parameter. For example, if the channel estimate parameter is a PER value, then the predetermined value may be a PER value that provides a nominal level of quality desired for a given communication session. The nominal level may vary according to the importance of the communication session. For example, a communication session using a secure connection may be deemed a communication session that needs a higher level of quality, and the predetermined value may be set to ensure the higher level of quality. The embodiments are not limited in this context.

As with CEM 202, link controller 204 may initiate scanning via CSM 206 in a number of different ways. For example, link controller 204 may generate a scan message in response to an external request, such as from a user of mobile device 106, a WAP, a subsystem of mobile device 106, and so forth. Link controller 204 may also send a scan message to CSM 206 on a periodic basis. For example, link controller 204 may send CSM 206 a scan message every 10 seconds. The time period for scanning may vary in accordance with a number of factors, such as the quality of the link as determined by link controller 204. If the link quality is higher, link controller 204 may have a first scanning period. If the link quality is lower, however, link controller 204 may have a second scanning period that comprises a smaller time interval than the first scanning period. The shorter scanning period may allow RMM 112 more time to find alternate wireless access points to compensate for the lower quality connection.

Link controller 204 may also include a channel identifier to identify a channel for CSM 206 to scan. For example, communication links 104 and/or 110 may comprise RF spectrum that may be divided into multiple channels having varying amounts of bandwidth. Link controller 204 may select which channel CSM 206 should scan using a number of different selection criteria, such as a type of channel, channel bandwidth, initial channel estimate values, and so forth. Alternatively, link controller 204 may perform channel selection using a “round robin” selection algorithm. The embodiments are not limited in this context.

In one embodiment, RMM 112 may include CSM 206. CSM 206 may scan for alternate wireless access points. For example, CSM 206 may receive the scan message from link controller 204. The scan message may include a channel identifier(s) and a scanning period. CSM 206 may begin scanning one or more channels during the scanning period. If a channel for other communication links to any available wireless access points within communication range of mobile device 106 is found, CSM 206 may store an identifier for each alternate communication link or WAP in an access point (AP) table.

CSM 206 may perform scanning operations in a number of different ways. For example, CSM 206 may temporarily interrupt or stop the normal “transmit/receive” mode to scan for other channels. CSM 206 may then send a “Power Save” message to the current WAP. Alternatively, CSM 206 may also scan for other channels in the background during time periods when mobile device 106 is idle, e.g., not transmitting or receiving information. The embodiments are not limited in this context.

If link controller 204 determines that the quality of an existing connection is lower than the predetermined value, link controller 204 may access the AP table to determine whether to switch mobile device 106 from an existing WAP to an alternate WAP. Link controller 204 may select an alternate WAP using a number of different factors, such as available bandwidth, signal strength, and so forth. Link controller 204 may generate a channel association message with the alternate WAP, and send the channel association message to CAM 208.

In one embodiment, RMM 112 may include CAM 208. CAM 208 may associate mobile device 106 with a given WAP. CAM 208 may receive the channel association message from link controller 204. CAM 208 may terminate a first connection with the current WAP, and create a second connection over a communication link with the alternate WAP. CAM 208 may create the second connection with the alternate WAP for the same or different communication session established using the first connection. If it is for the same communication session, communications between mobile device 106 and server 118 may remain operational while mobile device 106 transfers from one WAP to another WAP.

Operations for the above system and subsystem may be further described with reference to the following figures and accompanying examples. Some of the figures may include programming logic. Although such figures presented herein may include a particular programming logic, it can be appreciated that the programming logic merely provides an example of how the general functionality described herein can be implemented. Further, the given programming logic does not necessarily have to be executed in the order presented unless otherwise indicated. In addition, the given programming logic may be implemented by a hardware element, a software element executed by a processor, or any combination thereof. The embodiments are not limited in this context.

FIG. 3 illustrates a programming logic 300. Programming logic 300 may be representative of the operations executed by one or more systems described herein, such as system 100 and/or RMM 112. As shown in programming logic 300, a channel characteristic for a first connection over a first communication link may be estimated to form a channel estimate parameter at block 302. Examples of a channel estimate parameter may include a RSSI, PER, and error detection rate. A determination as to whether to roam may be made using the channel estimate parameter at block 304. A second communication link may be identified at block 306. The first connection may be terminated at block 308. A second connection may be created over the second communication link at block 310.

In one embodiment, the first connection and said second connection are for a same communication session. Alternatively, the first connection and the second connection are for a different communication session. The embodiments are not limited in this context.

In one embodiment, the determination at block 304 may be made by comparing the channel estimate parameter to a predetermined value. The determination whether to roam may be made in accordance with the results of the comparison.

In one embodiment, the identification at block 306 may be made by scanning for the second communication link. An identifier for the second communication link may be stored in an AP table. The second communication link identifier may be retrieved from the AP table.

In one embodiment, the creation at block 310 may be performed by sending a connection establish message to a second access point to create the second connection. An example of a connection establish message may be an “Active Mode” message sent to a WAP in accordance with a wireless LAN protocol, such as IEEE 802.11 or 802.16, for example.

The operation of the above described systems and associated programming logic may be better understood by way of example. Assume a user initiates a communication session between mobile device 106 and server 118. Assume the communication session is an application program such as an electronic mail program executed on mobile device 106, and server 118 is an electronic mail server. Mobile device 106 may establish a connection with WAP 102 via communication link 104. WAP 102 may establish a connection with server 118 via network 114. Electronic mail may be communicated between server 118 and mobile device 106 in a number of different ways, such as mobile device 106 pulling electronic mail from server 118 on a periodic basis during the communication session, server 118 pushing electronic mail to mobile device 106 on a periodic basis during the communication session, or a combination of both. In any case, it may be desirable that the communication session remain open until explicitly terminated by server 118 or mobile device 106.

RMM 112 may manage roaming operations for mobile device 106 in the event mobile device 106 needs to move from one WAP to another WAP. This may occur if mobile device 106 moves from one location to another location. This may also occur if mobile device 106 remains stationary, but is within range of two or more wireless access points.

For example, assume mobile device 106 moves from one location to another location while the communication session remains in progress. The movement of mobile device 106 away from WAP 102 may cause the connection established between mobile device 106 and WAP 102 over communication link 104 to degrade in quality. CEM 202 may monitor the connection and periodically send a channel estimate parameter to link controller 204. Link controller 204 may compare the channel estimate parameter with a threshold value. If the channel estimate parameter is below the threshold value, link controller 204 may send a scan message to CSM 206 to begin scanning for alternate communication channels. CSM 206 may find that mobile device 106 is within transmission range of WAP 108, and stores an identifier for WAP 108 in the AP table. Link controller 204 may select WAP 108 from the AP table, and send a channel association message to CAM 208. CAM 208 may terminate the current connection between mobile device 106 and WAP 102 over communication link 104, and create a new connection between mobile device 106 and WAP 108 over communication link 110. In this manner, the communication session between mobile device 106 and server 118 may remain operational while mobile device 106 transfers from WAP 102 to WAP 108.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

It is also worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

Some embodiments may be implemented using an architecture that may vary in accordance with any number of factors, such as desired computational rate, power levels, heat tolerances, processing cycle budget, input data rates, output data rates, memory resources, data bus speeds and other performance constraints. For example, an embodiment may be implemented using software executed by a general-purpose or special-purpose processor. In another example, an embodiment may be implemented as dedicated hardware, such as a circuit, an application specific integrated circuit (ASIC), Programmable Logic Device (PLD) or digital signal processor (DSP), and so forth. In yet another example, an embodiment may be implemented by any combination of programmed general-purpose computer components and custom hardware components. The embodiments are not limited in this context.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

While certain features of the embodiments have been illustrated as described herein, many modifications, substitutions, changes and equivalents will now occur to those skilled in the art. It is therefore to be understood that the appended claims are intended to cover all such modifications and changes as fall within the true spirit of the embodiments.

1. An apparatus, comprising:
a channel estimate module to estimate a channel characteristic for a first connection over a first communication link, and output a channel estimate parameter;
a link controller to connect to said channel estimate module, said link controller to receive said channel estimate parameter, and output a scan message;
a channel scan module to connect to said link controller, said channel scan module to receive said scan message, scan for alternate communication links, and store an identifier for each alternate communication link in an access point table; and
a channel association module to connect to said link controller, said link controller to retrieve an identifier for a second communication link from said access point table and output a channel association message to said channel association module, said channel association module to terminate said first connection and create a second connection over said second communication link.

2. The apparatus of claim 1, wherein said first connection and said second connection are for a same communication session.

3. The apparatus of claim 1, wherein said first connection and said second connection are for a different communication session.

4. The apparatus of claim 1, wherein said channel estimate parameter comprises at least one of a receive signal strength indicator, a packet error rate, and error detection rate.

5. The apparatus of claim 1, wherein said link controller is to compare said channel estimate parameter to a predetermined value, and generate said scan message in accordance with said comparison.

6. The apparatus of claim 1, wherein said channel scan module scans for alternate communication links on a periodic basis.

7. The apparatus of claim 1, wherein said channel scan module scans for alternate communication links at periodic intervals, with said interval to vary with said channel estimate parameter.

8. A system, comprising:
a first wireless access point;
a second wireless access point; and
a mobile device to establish a first connection with said first wireless access point, said mobile device to terminate said first connection and establish a second connection with said second wireless access point if a channel estimate parameter for said first connection is lower than a predetermined value.

9. The system of claim 8, wherein said mobile device comprises:
an antenna;
a transceiver to connect to said antenna; and
a roam management module to connect to said transceiver, said roam management module to comprise:
a channel estimate module to estimate a channel characteristic for said first connection over a first communication link, and output said channel estimate parameter;
a link controller to connect to said channel estimate module, said link controller to receive said channel estimate parameter, and output a scan message;
a channel scan module to connect to said link controller, said channel scan module to receive said scan message, scan for alternate communication links, and store an identifier for each alternate communication link in an access point table; and
a channel association module to connect to said link controller, said link controller to retrieve an identifier for a second communication link from said access point table and output a channel association message to said channel association module, said channel association module to terminate said first connection and create said second connection over said second communication link.

10. The system of claim 8, wherein said channel estimate parameter comprises at least one of a receive signal strength indicator, a packet error rate, and error detection rate.

11. The system of claim 8, wherein said first connection and said second connection are for a same communication session.

12. The system of claim 8, wherein said first connection and said second connection are for a different communication session.

13. A method, comprising:
estimating a channel characteristic for a first connection over a first communication link to form a channel estimate parameter;
determining whether to roam using said channel estimate parameter;
identifying a second communication link;
terminating said first connection; and
creating a second connection over said second communication link.

14. The method of claim 13, wherein said first connection and said second connection are for a same communication session.

15. The method of claim 13, wherein said first connection and said second connection are for a different communication session.

16. The method of claim 13, wherein said channel estimate parameter comprises at least one of a receive signal strength indicator, a packet error rate, and error detection rate.

17. The method of claim 13, wherein said determining comprises:
comparing said channel estimate parameter to a predetermined value;
determining whether to roam in accordance with said comparison.

18. The method of claim 13, wherein said identifying comprises:
scanning for said second communication link;
storing a second communication link identifier in an access point table; and
retrieving said second communication link identifier from said access point table.

19. An article, comprising:
a storage medium;
said storage medium including stored instructions that, when executed by a processor, are operable to estimate a channel characteristic for a first connection over a first communication link to form a channel estimate parameter, determine whether to roam using said channel estimate parameter, identify a second communication link, terminate said first connection, and create a second connection over said second communication link.

20. The article of claim 19, wherein the stored instructions, when executed by a processor, perform said determining using stored instructions operable to compare said channel estimate parameter to a predetermined value, and determine whether to roam in accordance with said comparison.

21. The article of claim 19, wherein the stored instructions, when executed by a processor, perform said identifying using stored instructions operable to scan for said second communication link, store a second communication link identifier in an access point table, and retrieve said second communication link identifier from said access point table.
